(19) United States
(12) Patent Application Publication
(10) Pub. No.: US 2025/0091697 A1
(43) Pub. Date: Mar. 20, 2025

(54) Floating offshore support structure for a wind turbine and a method of its operation using adjustable-ballast reservoirs

(71) Applicant: Stiesdal Offshore A/S, Give (DK)

(72) Inventor: Henrik Stiesdal, Odense C (DK)

(21) Appl. No.: 18/954,844

(22) Filed: Nov. 21, 2024

Related U.S. Application Data
(63) Continuation of application No. PCT/DK2023/050132, filed on May 30, 2023.

(30) Foreign Application Priority Data
May 31, 2022 (DK) PA 2022 00507

(51) Int. Cl. B63B 39/03; B63B 35/44

(52) U.S. Cl. CPC B63B 39/03; B63B 35/44; B63B 2035/446

(57) ABSTRACT

A semisubmersible offshore support structure for a wind turbine carries an adjustable-ballast reservoir above sea level fillable with water for providing extra load on a part of the support structure. By adjusting the water volume in the adjustable-ballast reservoirs, the wind turbine can be maintained in vertical orientation despite wind pressure. A drain is provided for draining water from the reservoir into the sea by gravity only for emptying the reservoir passively in case of power failure.

### CROSS-REFERENCE TO RELATED APPLICATIONS

This application is a continuation under 35 U.S.C. 111 of International Patent Application No. PCT/DK2023/050132, filed May 30, 2023, which claims the benefit of and priority to Danish Application No. PA 2022 00507, filed May 31, 2022, each of which is hereby incorporated by reference in its entirety.

### FIELD OF INVENTION

The present invention relates to an active ballasting system for a floating offshore support structure for a wind turbine. In particular, it relates to a system and a method of its operation.

### BACKGROUND

Floating offshore support structures for wind turbines enable the exploitation of the offshore wind resource over much larger areas than possible when relying on bottom-fixed foundations. The International Energy Agency estimates that the introduction of floating offshore structures expands the total offshore wind resource that can be developed on commercial terms by a factor of 10.

Floating offshore support structures for wind turbines need to have adequate buoyancy and stability to support the wind turbine. They are typically hull structures fabricated of steel or concrete shells.

The most common type of floating offshore support structure for wind turbine support is the semisubmersible. Semisubmersibles typically consist of multiple columns located with considerable lateral distance. The center of gravity is above the center of buoyancy, and stability of the structure when exposed to overturning moments caused e.g. by the wind load on the wind turbine rotor and tower is achieved by the restoring moment of the columns when submerged to varying extents as a consequence of the loads acting on the wind turbine. The floating structure is kept in position by a mooring system, consisting of catenary or taut spread mooring lines and drag or suction anchors.

An example of a monopile structure and with mooring lines is disclosed in South Korean patent application KR2010-0057550A. During installation, ballast tanks, which are provided above the water surface, are used for lowering the vertical position of the support structure in order to install the mooring lines, after which the ballast tanks are drained again.

Chinese patent application CN112319691A discloses a general principle for filling and emptying a ballast tank for a floating wind power platform.

The restoring moment is a function of the inclination of the floating structure. When exposed to an overturning moment caused e.g. by the wind load on the wind turbine rotor and tower, the floating structure will incline until the restoring moment caused by the different submersion of the columns is equal to and in the opposite direction of the overturning moment. Consequently, a certain overturning moment corresponds to a certain angle of inclination.

Inclination of the floating support structure is associated with certain disadvantages.

Firstly, in addition to the overturning moment at the tower bottom caused by the wind load on the wind turbine rotor and tower itself, a supplementary overturning moment will arise caused by the weight of the wind turbine nacelle and the tower. The tower is normally oriented vertically when no wind loads affect the structure, and gravity loads from the weight of the wind turbine are typically close to the centerline of the tower. These gravity loads will be offset as a consequence of the inclination, and the offset may give rise to considerable additional loads.

Secondly, the axis of rotation of the wind turbine rotor will no longer have its normal direction but will have an angular deviation corresponding to the angle of inclination. On modern wind turbines, in order to achieve sufficient blade clearance to the tower the axis of rotation is typically tilted by about 5 degrees relative to horizontal. The power performance of a wind turbine rotor is a function of the cosine of the angle of tilt lifted to a power of 2.5, and at a rotor tilt angle of 5 degrees the power performance is reduced by 0.9% relative to the power performance at zero rotor tilt angle. This reduction is taken into account when predicting the annual energy output. However, if the tower is inclined as a consequence of the wind load acting on the wind turbine rotor and tower, the result will be a somewhat larger reduction in power output. For example, an inclination angle of 5 degrees will give rise to a total tilt angle of 10 degrees. At this rotor tilt angle the power performance is reduced by 3.8% relative to the power performance at zero rotor tilt angle, and by 2.9% relative to the power performance at the standard 5 degrees rotor tilt angle.

In the light of these disadvantages, it would be advantageous to make arrangements to ensure that the inclination of the floating structure is kept to a minimum.

The inclination of the floating support structure can be adjusted by differential ballasting of the structure.

European patent application EP3366567 and US2011/037264, both assigned to Principle Power Inc, disclose floating support structures for a wind turbine in which buoyancy reservoirs at a distance to the tower have variable content of water in order to adjust and balance the structure with the wind turbine when wind is exerting pressure on the wind turbine. Water is repeatedly pumped between reservoirs by pumps, of which there are provided two in each connecting pipe which yields redundancy for the event that a pump should break down. Such redundancy is important in order to maintain proper functioning of the system.

However, in case that there is a general power failure, the redundant pumps may also stop working. It would be desirable to provide a safe system also for such event of general power failure.

Chinese patent application CN107685838A discloses a semi-submersible crane platform with a crane near one edge of the platform. A ballast system with multiple ballast tanks in stand columns is used for balancing. During crane lift, water flows from filled upper tanks above the water surface on the crane side of the platform to empty lower tanks under the water surface on the other side by gravity in order to counteract inclination. When releasing the load, water flows from filled upper tanks on the opposite side of the platform to empty lower tanks on the crane side by gravity in order to counteract inclination in the opposite direction. Alternatively, the water from the upper tanks is discharged by gravity, and water inserted from the outside into the lower underwater tanks by gravity. The system is configured for one flow of water into the lower, empty tanks on one side during crane lifting and one flow into the lower, empty tanks on the other side when releasing the load. The lifting process can be controlled for one hour duration. After the lifting and releasing process, the lower tanks have to be emptied and the upper filled again before the next crane lift. The valves that determine the flow are remotely controlled. This system is not disclosed for dynamic adjustment during varying wind load. Also, no technical solution is disclosed in case of power failure.

### BRIEF DESCRIPTION

It is an objective to provide an improved construction and operation of floating offshore structures for wind turbines, especially for semisubmersible structures with ballast reservoirs at nodes of the structure that can be filled with water ballast to varying degrees, which improves safety in the event of failure of the pumps, for example when a general power failure occurs. This objective as well as further advantages are achieved by an offshore wind turbine system as well as a method of its operation as set forth below.

In short, a semisubmersible offshore support structure for a wind turbine carries one or more adjustable-ballast reservoirs above sea level and fillable with water for providing extra load on the respective part of the support structure. By adjusting the water volume in the adjustable-ballast reservoir, the wind turbine can be maintained in vertical orientation despite wind pressure. A drain system is provided for draining water from the reservoir into the sea by gravity only for emptying the reservoir passively in case of power failure.

The system is explained in more detail in the following.

The floating offshore wind turbine system comprises a wind turbine in combination with a semisubmersible support structure for floating in a water body at a water surface. For example, the offshore location is in sea water but can also be a lake or other offshore body of water. For simplicity, it is exemplified in the following for sea water without delineating from the general principle of use in other offshore waters, such as lake water.

The semisubmersible floating support structure comprises a tower support that carries a tower of the wind turbine and comprises at least one buoyancy member, but typically a plurality of buoyancy members, providing buoyancy to the support structure when in water. For example, the buoyancy members are arranged at lateral distances relatively to a central axis of the tower, typically a vertical axis. Typically, each buoyancy member comprises one or more buoyancy columns fixed to a node of the support structure. Such buoyancy columns may typically be made of steel or reinforced concrete.

The buoyancy members and parts of the support structure are optionally configured to be partly fillable with permanent ballast during installation of the system to ensure balancing of the structure and achieving a desired operational draft. Such permanent ballast is optionally in the form of sea water. Using sea water has the advantage that the permanent ballast may be removed again, for example in case the floating structure needs to be towed back to a port for maintenance where such port does not have the water depth required to berth the floating structure at its operational draft. However, during operation of the wind turbine at sea, the amount of sea water for such permanent ballast in corresponding permanent ballast tanks is normally not changed. Typically, at least a major portion, if not all of the permanent ballast sea water is under the water surface for stability reasons.

According to an embodiment of the present invention, different from the optional permanent ballast, the support structure comprises at least one reservoir with an adjustable amount of water as ballast, in the following accordingly called an adjustable-ballast reservoir. An adjustable-ballast reservoir has an effective volume that is arranged distal to the tower support and configured for being filled with water for providing extra load on the support structure by gravitation as a restoring force that counteracts inclination of the tower relative to a predetermined orientation, despite variations in wind pressure.

In particular, the adjustable-ballast reservoir has a water-fillable volume, or at least an effective part of the volume, arranged above the water surface. It is arranged such that it maintains a position above the water surface when the system is in operation, even under inclined conditions of the support structure and the wind turbine tower.

This has to be understood such that the adjustable-ballast reservoir has a water-fillable volume, or at least an effective part of the volume, arranged above the water surface most of the time, so that the functioning of the system, especially the drainage, is maintained, despite the water-fillable volume, or at least an effective part of the volume, being shortly under the water surface due to some of the higher waves changing the water surface level while passing the reservoir. In an average over time, however, the volume, or at least an effective part of the volume, is above the water surface, despite some waves potentially changing the condition for a short moment. Important in this relation is that the water-fillable volume, or at least an effective part of the volume, is above the water surface sufficiently long that it can perform the function without substantial disturbance, despite waves. For example, the volume, or at least an effective part of the volume is arranged such that it maintains a position above the water surface at least 90% or even at least 95% of the operation time. In other words, the influence of waves passing by is less than 10% or even less than 5% of the time of normal operation.

The term normal operation is here used to differentiate from extreme weather conditions, such as storms, with unusually high waves, which may change the water level drastically and abruptly for a short time.

For filling the adjustable-ballast reservoir, the system comprises a water intake for intake of water under the water surface from the water that surrounds the support structure and a pumping system for pumping the water, for example sea water if the water body is a sea, from the intake through a conduit into the adjustable-ballast reservoir. A drain system is provided for draining water from the adjustable-ballast reservoir back into the sea water of the body of water that surrounds the adjustable support structure and in which it is floating.

Notice that the system for the repeated adjustment of the inclination receives water from the body of water in which the structure floats and returns water into the water body. Thus, for the adjustable-ballast reservoirs, the floating support structure needs no storage tank. Also, there is no flow between such adjustable-ballast reservoirs if multiple of such adjustable-ballast reservoirs are used.

Advantageously, the drain system is configured for draining water from the ballast reservoir back into the water that surrounds the adjustable support structure only by gravity for emptying the adjustable ballast reservoir passively in case of power failure.

In offshore wind turbine systems that are held by a single point mooring, the support structure with the wind turbine will orient itself in a downstream location of the wind direction, and the inclination will change only in the wind direction in dependence of the wind speed. In this case, a single ballast-adjustment reservoir is sufficient for achieving a restoring effect.

For stationary systems that are fastened to the seabed by several mooring lines, a plurality of such adjustable-ballast reservoirs is used for proper counteracting and adjusting inclination, typically at least three adjustable-ballast reservoirs, although, in some cases, two adjustable-ballast reservoirs can be sufficient for the purpose.

The adjustable-ballast reservoirs are distributed at different azimuth angles about the axis of the tower in a plane lateral to the axis for adjusting the inclination of the tower in different lateral directions by individually adding or draining water from the ballast reservoirs. For being used as counterweight, the adjustable-ballast reservoir, or at least a major portion of it, is arranged at a distance to the tower.

In some embodiments, for adjustment of the inclination, multiple adjustable-ballast reservoirs are fillable individually and independently from each other and can correspondingly also be individually emptied.

For example, the floating support structure comprises multiple buoyancy members, each fitted, for example on its top, with an adjustable-ballast reservoir above the sea water surface. The adjustable-ballast reservoir is fillable with water for providing additional vertical gravitational load on the respective buoyancy member of the floating support structure.

This additional vertical gravitational load is used for balancing the structure and maintaining the inclination of the floating support structure at a predetermined level, for example a level that results in a vertical orientation of the wind turbine tower, despite variations in wind pressure on the wind turbine structure.

The buoyancy members of the floating support structure that are fitted with adjustable-ballast reservoirs above the sea water surface are optionally the columns providing the restoring moment to the floating support structure as a result of the different submersion of the columns. Other members of the floating support structure, for example braces that form a grid-structure, may also be fitted with adjustable-ballast reservoirs above the sea water surface.

In the following, the system applied to fill and drain the adjustable-ballast reservoirs is an active ballasting system.

The active ballasting system comprises one or more pumps for pumping water from an intake through a conduit into the adjustable-ballast reservoirs. The intake reaches into the sea water in the surroundings of the structure under the water surface.

Furthermore, each adjustable-ballast reservoir comprises a drain for draining water from the adjustable-ballast reservoir back into the sea outside the support structure by gravity only. This way, the adjustable-ballast reservoir can be passively emptied of water in case of power failure, which is important in order to reduce risk of the system capsizing and also for returning to an orientation of the wind turbine tower that yields safe access to the system for repair.

For example, the adjustable-ballast reservoir has a water fillable volume, or at least an effective part of its volume, that is entirely above the water surface and at a distance to the water surface when the support structure is oriented at the predetermined angle of inclination. Due to the positioning of the effective part of the volume above the water surface, it can be completely or largely emptied by gravity drainage, and no active pumping is required for the emptying. Advantageously, for emptying the effective part of the volume even in case of power failure, the reservoir has a volume, or at least an effective part of its volume, that is entirely above the water surface at all times in offshore operation, even when the structure is inclined.

In these cases, the water fillable volume, or at least an effective part of its volume, is, advantageously, entirely above the water surface at all times in normal offshore operation and even above the typical waves that are to be expected during normal operation. Deviations from normal operation are occurrences of unexpected high waves in extreme weather conditions. Such waves may be unlikely or so seldom that they are not taken into account in the dimensioning for normal operation. This is especially so because the time where the water is flowing higher than the effective part, and possibly even over or onto the reservoir, in such unexpected high-wave conditions is only of short duration so that it has no substantial effect on the overall functioning of the system, especially on the water drainage. In other words, even in the special case of extreme weather conditions with particularly high waves that change the water level abruptly and substantially and may even flush over the reservoir, the functioning principle of the system, especially the drainage system, is maintained due to the relatively short duration of such extreme waves.

In some embodiments, an individual pump is provided for each of the adjustable-ballast reservoirs, so that each single of the pumps is pumping sea water into only one respective of the adjustable-ballast reservoirs.

In some embodiments, the system is free from interconnection of the adjustable-ballast reservoirs by water conduits. No water is flowing from one reservoir to the other. Water can be filled into an adjustable-ballast reservoir and drained from this adjustable-ballast reservoir independently from the other adjustable-ballast reservoirs.

In some practical embodiments, each ballast reservoir has a drain that is constantly open, also during filling of the ballast reservoir. The drain is configured for emptying the volume, or the effective part of the volume, of the adjustable-ballast reservoir within a predetermined time, for example within less than 6 hours, optionally less than one hour, if no sea water is added to the adjustable-ballast reservoir in the meantime. In a simple version, the drain is an opening that is always open and drains constantly as soon as and as long as there is water inside the adjustable-ballast reservoir.

In order to fill water into the adjustable-ballast reservoir, despite the constant drain of water from the reservoir, the pump system has a capacity for pumping water into the reservoir at a rate of inflow into the reservoir exceeding the rate of outflow from the reservoir through the drain system.

In some practical embodiments, each adjustable-ballast reservoir can be drained through the pump when the rotational speed of the pump is less than the speed required to maintain the output pressure of the pump at a level counteracting the hydrostatic pressure from the water in the adjustable-ballast reservoir.

In order to fill water into the adjustable-ballast reservoir, despite the hydrostatic pressure from the water in the adjustable-ballast reservoir, the pump can be operated at a speed that is higher than the speed required to maintain the output pressure of the pump at a level counteracting the hydrostatic pressure from the water in the adjustable-ballast reservoir.

Alternatively, or in addition, active drain valves may be provided for drainage of the adjustable-ballast reservoirs.

An active drain valve may be configured as an electrically controlled valve, for example driven by a solenoid or an electric motor. The active drain valve is optionally configured so as to be actively closed under remote control but being normally open for automatic drainage of the adjustable-ballast reservoir through the active drain valve in case of a power failure. For example, there is provided an individual active drain valve for each adjustable-ballast reservoir. Alternatively, a single active drain valve is used and conduit-connected to all adjustable-ballast reservoirs for emptying all reservoirs through the single active drain valve.

Alternatively, or in supplement, an active drain valve may be configured as a pilot-controlled valve, using the pressure from the respective pump to determine the opening and closing of the valve. When the pump is feeding water to the adjustable-ballast reservoir through the conduit, the pressure in the conduit will be higher than the hydrostatic pressure from the water in the adjustable-ballast reservoir. This pressure difference can be used to operate the pilot-controlled active drain valve. The pilot-controlled active drain valve is configured to be closed when the pressure in the conduit is higher than the hydrostatic pressure from the water in the adjustable-ballast reservoir, and configured for being open when the pressure in the conduit is equal to or lower than the hydrostatic pressure from the water in the adjustable-ballast reservoir. The pilot-controlled active drain valve is optionally located at the adjustable-ballast reservoir, but can be located at any other suitable location.

In operation, the actual inclination of the floating support structure is measured by sensors of a control system. Inclinometers are useful sensors in this respect. Optionally, the control system may also or exclusively use accelerometers. If the inclination is deviating from a predetermined orientation, typically vertical orientation of the wind turbine tower, for example causing at least a first of the buoyancy members to be elevated higher out of the water and a second of the remaining buoyancy members to sink deeper into the water, the inclination is counteracted by pumping water into one or more of the adjustable-ballast reservoirs carried by one or more of the buoyancy members that are elevated higher out of the water, causing the additional weight of the water pumped into such adjustable-ballast reservoir(s) to act as counterweight. Alternatively, or in addition, water may be drained from the adjustable-ballast reservoir or reservoirs carried by one or more members that are sunk deeper into the water, causing the reduced weight of the water drained from such adjustable-ballast reservoir(s) to act in the opposite direction of a counterweight.

The system is generally used for adjustment during normal operation. If the wind increases and the inclination changes to deviate from a predetermined optimum inclination, the system is programmed to restore the optimum conditions.

In some embodiments, the pump is operated intermittently at a constant pumping speed. The filling rate of water into the respective adjustable-ballast reservoir is then regulated by stopping and starting the pump.

In some embodiments, the pump is operated intermittently or constantly at variable pumping speed. The filling rate of water into the respective adjustable-ballast reservoir is then regulated by varying the pumping speed and possibly also by stopping and starting the pump.

In some embodiments, the draining rate is a simple function of the hydrostatic pressure in the adjustable-ballast reservoir, draining happening through a fixed drainage, for example through a drainage hole in the adjustable-ballast reservoir or through the pump.

In some embodiments, the draining rate is regulated by varying the pump operation, relying on drainage through the pump. Variation of pump operation may be through starting and stopping of the pump or through varying the speed of the pump.

In some embodiments, the draining rate is regulated by controlling the drainage rate through an active drain valve. The draining rate of such active drain valve may be regulated directly, for example by solenoid control or motor control of an electric active drain valve, or indirectly by varying the pump pressure, or activating a pilot-controlled active drain valve.

In some embodiments, constant operation of the pump is required to maintain the inclination of the floating support structure at a predetermined level. For example, this is the case where the adjustable-ballast reservoir is fitted with a fixed drain that is always open, or where drainage through the pump is applied. Although this may appear as a waste of power at first sight, it is pointed out that the power consumption by a constantly running pump is negligible relative to the power production, and acceptable in view of the high operational passive safety achieved by such a simple system. However, more remarkable, though, is the fact that the system with its constant regulation of optimized inclination of the tower results in a power production gain which by far exceeds the power consumption for the pumping.

In the following, some figures are given in short form as examples of concrete numbers for a possible wind turbine system.

### Power Required to Compensate for Leakage

Overturning moment 350,000 kNm
Radius 45 m
Restoring force needed 8000 kN
Restoring mass needed m=800 tons
Lifting height h=10 m above sea surface
Potential energy E=m g h=800,000 kg*10 m/s2*10 m=80,000,000 J
Time for drainage T=6 h=21,600 s
Power requirement net (no losses assumed) Po=E/T=80,000,000/21,600 W=3.7 KW
Power requirement gross assuming total losses of 50% P=2 Po=7.5 kW
   Rule of Thumb for Power Output from Offshore Wind Turbine:
a. ⅓ of time no power
b. ⅓ of time power increasing linearly from zero to rated, with average power equal to 50% of rated, and with energy output equal to ⅓ of total energy output.
c. ⅓ of time rated power

### Energy Loss Due to Ballasting

It is assumed that two of the three pumps will always be operational
During operation in mode a, no losses and no power output
During operation in mode b, 15 KW losses and 7.5 MW power output=0.2%. During operation in mode c, 0 KW of losses (because the turbine automatically compensates by producing 15 KW more power) and 15 MW power output
Total losses 0.2%*⅓=0.06%

### Energy Gain Due to Ballasting

During operation in mode a, no losses and no power output
During operation in mode b, 2.9% higher power, assuming an average inclination angle of 5 deg. and a cos\hat{ }2.5 relationship.
During operation in mode c, 0 KW of losses (because the turbine automatically compensates)
Total gain 2.9%*⅓=1.0%

### Total Effect of Ballasting

Total losses 0.2%*⅓=0.06%
Total gain 2.9%*⅓=1.0%
Resulting net gain 1.0%−0.06%=0.9%

At a power price of 50 EUR per MWh this resulting power gain involves a monetary equivalent in excess of 300,000 EUR over the project lifetime.

### BRIEF DESCRIPTION OF THE DRAWINGS

The disclosed systems will be explained in more detail with reference to the drawings, where

FIG. 1 is a drawing in three-dimensional perspective view of an offshore wind turbine installation;

FIG. 2A is a side view of the offshore wind turbine installation in conditions without wind;

FIG. 2B is a side view of the offshore wind turbine installation in conditions with wind, where the tower is inclined;

FIG. 2C is a side view of the offshore wind turbine installation in conditions with wind, where the tower has been reset into vertical due to filling of an adjustable-ballast reservoir;

FIG. 3A is a front view of the support structure in conditions without wind,

FIG. 3B is a front view of the support structure in conditions with wind, where the tower is sideways inclined;

FIG. 3C is a front view of the support structure in conditions with wind, where the tower has been reset into vertical due to filling of an adjustable-ballast reservoir;

FIGS. 4A, 4B, 4C and 4D illustrate variations of semisubmersible offshore wind power systems;

FIG. 5 illustrates the pumping and draining system, according to an embodiment;

FIGS. 6A and 6B illustrate an example of an active ballasting system during A) filling and B) emptying;

FIGS. 7A, 7B and 7C illustrate an alternative example of an active ballasting system during A) filling and B) emptying and C) steady state; and

FIGS. 8A and 8B illustrate an alternative example of an active ballasting system A) using an additional drain and B) when holding steady state.

### DETAILED DESCRIPTION

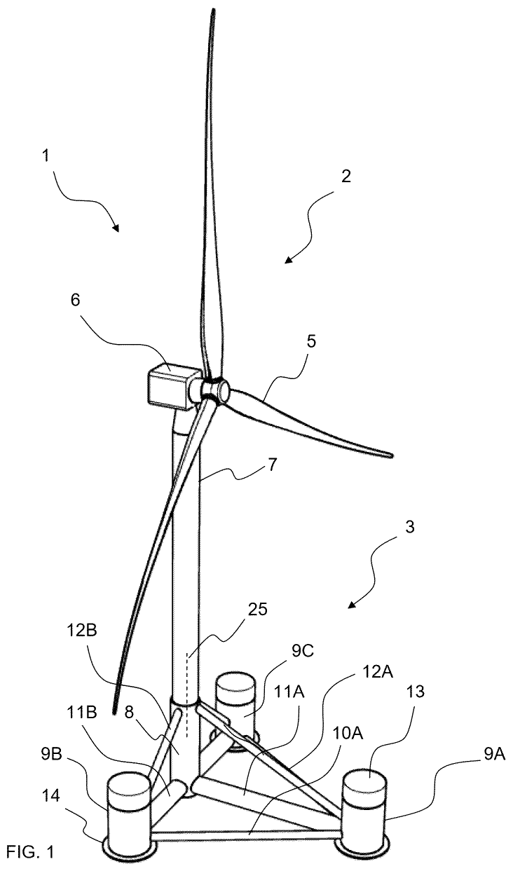

FIG. 1 illustrates an offshore wind turbine installation 1. The installation 1 comprises a wind turbine 2 and an offshore support structure 3 with a tower support 8 on which the wind turbine 2 is mounted for operation and by which it is supported in offshore conditions. The wind turbine 2 comprises a rotor 5 and a tower 7 and nacelle 6 that connects the rotor 5 with the tower 7.

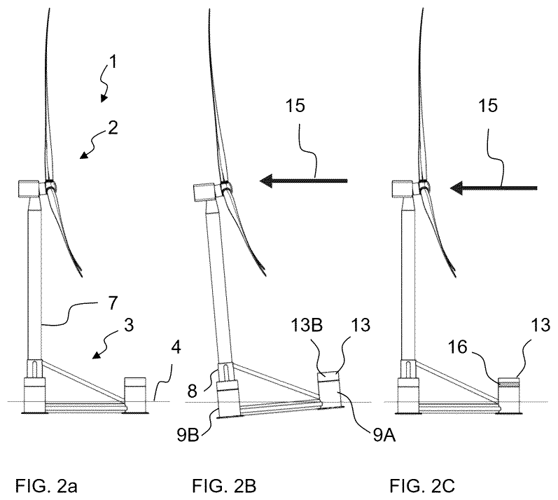

The offshore support structure 3 is a semisubmersible floating offshore structure with buoyancy members 9A 9B, 9C that assist in keeping the support structure 3 partially above water and which give the floating structure stability. An example of a water surface 4 relative to the vertical extension of the buoyancy members 9A 9B, 9C is illustrated in FIG. 2A. It is observed that the buoyancy members 9A 9B, 9C are semi-submersed in the water.

Semisubmersible support structures are typically used with mooring lines (not shown) fastened to the seabed in order to maintain the support structure 3 at the location. For vertically damping influence of waves on the floating support structure 3, heave plates 14 extend horizontally from the bottom of the buoyancy members 9A, 9B, 9C.

The exemplified structure 3 has a tetrahedral shape comprising a first radial brace 11A that extends from a lower part of the tower support 8 to the first buoyancy module 9A at the most distal node, relative to the tower support 8, and two further radial braces 11B that extend from the lower part of the tower support 8 to each of the other two remaining buoyancy modules 9B, 9C at nodes on opposite sides of the tower support 8. Further stability is achieved by two additional braces 10A that extend from the most distal buoyancy member 9A to the two other buoyancy members 9B, 9C. The two additional side braces 10A form a planar triangular shape with the two shorter radial braces 11B and with the buoyancy members 9A, 9B, 9C at each of the three nodes of the tetrahedron.

The term radial braces is used for braces 11A, 11B that extend radially away from the tower support 8, and the term diagonal brace is used for a brace 12A, 12B that is a diagonal side of a vertical triangle formed by the tower support 8, one of the radial braces 11A, 11B and one of the diagonal braces 12A, 12B.

It is pointed out that the form of the tetrahedral structure is an example only, and the support structure could alternatively be provided as any other suitable structure comprising multiple columns located a considerable lateral distance from tower support 8.

The tower support 8 is exemplified as a support column with a central cylindrical axis 25 that is also a central axis of the tower 7. However, the tower support 8 could have other shapes. As illustrated in FIG. 2A, the tower support 8 extends to a position above the water surface 4, which is also characteristic for such type of floating support structures.

In FIG. 2A, a situation is shown in which the wind speed is zero. The support structure 3 is balancing the wind turbine so that the tower 7 of the wind turbine 2 is vertical.

In FIG. 2B, a situation is shown in which wind, illustrated by arrow 15, pushes against the wind turbine 2. The pressure from the wind 15 causes the tower 7 to tilt away from the wind 15, resulting in the distal buoyancy member 9A being pressed upwards more out of the water, whereas the opposite two buoyancy members 9B, 9C, which are provided at nodes that are closer to the tower support 8, are pressed deeper into the water.

In FIG. 2C, water 16 has been pumped into an upper adjustable-ballast reservoir 13 that is provided on top of the distal first buoyancy member 9A in order to restore proper balance. The weight of the water 16 in an effective part 13B of the volume of the adjustable-ballast reservoir 13 presses the distal buoyancy member 9A by gravity downwards, which re-establishes balance, so that the tower 7 attains a vertical orientation again, despite wind pressure 15. Partial filling and emptying of the adjustable-ballast reservoir 13 is done continuously during operation in order to assist in balancing the installation 1.

Should the desired orientation of the wind turbine tower 7 deviate from vertical, for example by a few degrees, the system can be correspondingly controlled for such orientation.

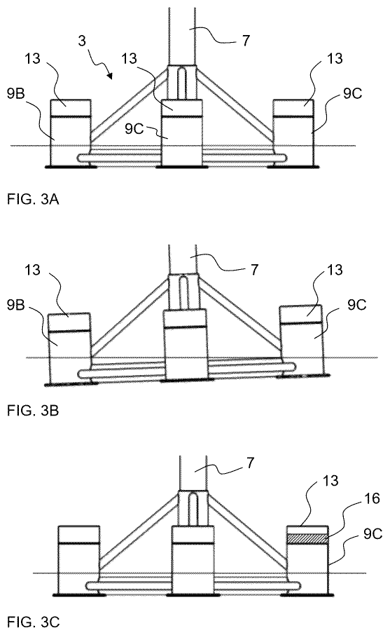

Three buoyancy members 9A, 9B, 9C, each provided with an adjustable-ballast reservoir 13 above the water line 4, can also be used to create and maintain balance when the wind 15 pressure or some other force acting on the wind turbine and/or the floating structure, such as wave and current, has a component acting sideways on the tower 7. Such situation is illustrated in FIGS. 3A-3C.

FIG. 3A illustrates a situation in which the support structure 3 is balancing the wind turbine so that the tower 7 of the wind turbine is vertical.

In FIG. 3B, a situation is shown in which wind pushes from the right against the wind turbine 2. The pressure from the wind causes the tower 7 to tilt away from the wind, resulting in one of the buoyancy members 9C being pressed upwards more out of the water, whereas the opposite buoyancy member 9B, which is also provided at a node that is closer to the tower support 8, is pressed deeper into the water.

In FIG. 3C, water 16 has been pumped into an upper adjustable-ballast reservoir 13 that is provided on top of the third buoyancy member 9C in order to create balance. The weight of the water 16 in the adjustable-ballast reservoir 13 presses the corresponding buoyancy member 9C by gravity downwards, which re-establishes balance so the tower 7 is vertical again. Partial filling and emptying of the adjustable-ballast reservoir 13 is done continuously during operation in order to assist in balancing the installation 1.

The filling and emptying of the adjustable-ballast reservoirs is typically done by computer control.

As all three buoyancy members 9A, 9B, 9C are equipped with an adjustable-ballast reservoir 13, balance with a vertical tower orientation can be established in any direction, irrespective of wind and waves and water current acting on the wind turbine 2 and/or on the support structure 30.

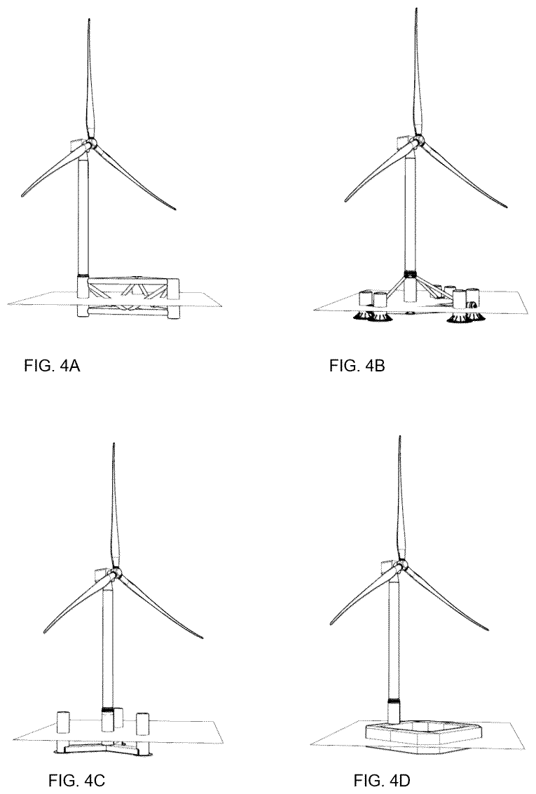

FIGS. 4A-4D illustrate a variety of configurations for a support structure in which the adjustable-ballast reservoirs, as described herein, are used. FIG. 4A illustrates a support structure where the tower support is provided in a corner of a horizontal triangle, and where buoyancy members are single columns arranged at corners of that triangle. In FIG. 4B, the tower support is arranged centrally between buoyancy members, each of which comprises two buoyancy columns. FIG. 4C illustrates a position of the tower support centrally between three buoyancy members arranged in a triangular configuration and connected by horizontal bottom bars, which optionally serves as tanks for sea water as permanent ballast. In FIG. 4D, the support structure is largely rectangular with blunt corners. Typically, buoyancy members are extending above the surface and permanent ballast is under the surface.

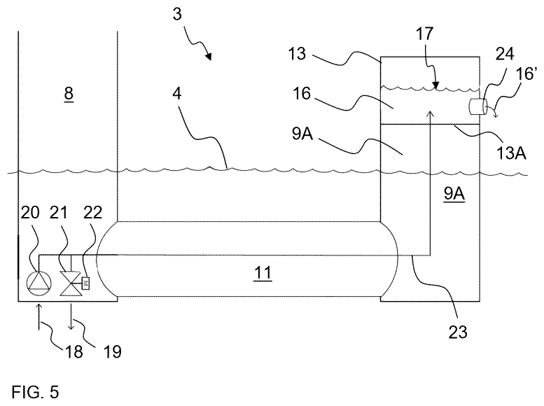

FIG. 5 illustrates an example of controlling the level 17 of the water 16 in the adjustable-ballast reservoir 13 carried by the buoyancy member 9A of the semisubmersible support structure 3. Notice that the adjustable-ballast reservoir 13 is above the surface 4 of the sea. The water 16 in the adjustable-ballast reservoir 13 is provided from the surrounding sea through an inlet 18 under the water surface 4, and the sea water is pumped by a pump 20 through the conduit 23 into the reservoir 13.

In some optional embodiments, water 16 can be drained from the reservoir 13 through conduit 23 and an actively controlled valve 21, controlled for example by a motor 22 for release 19 of water into the sea again. Advantageously, the valve 21 is a normal-open valve so that failure of electrical current results in the valve 21 being open and emptying the reservoir 13.

In some embodiments, the pumping rate of the pump 20 is regulated according to the needs of water in the adjustable-ballast reservoir 13. In other embodiments, the pump 20 is pumping constantly, and the valve 21 is regulated by the motor 22 so that regulation of the valve 21 and not regulation of the pump 20 determines whether and how much water 16 is pumped into the reservoir 13. This embodiment has an advantage of minimizing electronic control, which adds to robustness of the system.

In some embodiments, as a further option or as an alternative to the valve 21, for assuring that the reservoir 13 is emptied in case of power failure, the reservoir 13 is potentially provided with a passive drain 24 that is always open and which constantly releases water 16′ from the reservoir 13. This implies that the pump 20 has to pump new water 16 into the reservoir 13 in order to replenish the drained water 16′ and maintain a certain predetermined water level in the reservoir 13. As the water 16 pumping capacity of the pump 20 is higher than the water 16′ drain speed through the drain 24, changing the water 16 level in the reservoir 13 is achieved by regulation of the pumping speed and/or regulation of the drain 19 through the valve 21 during pumping, if such valve 21 is provided. Constant pumping implies power consumption at all times when there is water 16 in the reservoir 13. However, for a drain 24 that is configured to drain the reservoir 13 within a time frame in the range of 1 to 12 hours, for example within a range of 1 to 6 hours, the additional power consumption by the pumping is relatively small and justified in comparison to the simplicity of the safety system and the avoidance of mechanical and electrical components that could fail and prevent emptying of the reservoir with potential risk of capsizing of the wind turbine.

For example, for each of the adjustable-ballast reservoirs 13, there is provided an independent pump 20 with individual conduits 23, optionally each being provided with an individual water intake 18 and exit 19. This avoids connection between the reservoirs 13. In other words, the system is free from interconnection of the adjustable-ballast reservoirs 13 by water conduits. No water is pumped from one reservoir 13 to another.

The pumps 20 are advantageously located in the tower support 8, although, this is not strictly necessary. Typically, the pumps 20 are located at or below sea surface level 4.

The control and operation of the pump 20 and/or the valve 21 is regulated automatically, for example by using inclination sensors. As further options, accelerometers are used.

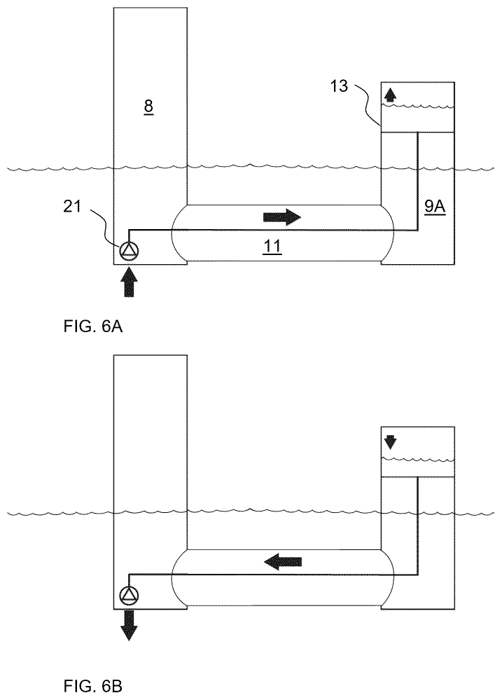

With general reference to the reference numbers of FIG. 5, of which only a few are used in FIGS. 6A and 6B, although, they find equal application, FIG. 6A illustrates an embodiment in which a pump 21 is used for filling sea water into the adjustable-ballast reservoir 13, which is illustrated by thick arrows. As illustrated in FIG. 6B, water is drained from the reservoir 13 backwards through the pump back into the surrounding sea when the pump 21 stops operation or, alternatively, when the rotational speed of the pump 21 is less than the speed required to maintain the output pressure of the pump at a level counteracting the hydrostatic pressure from the water in the adjustable-ballast reservoir 13.

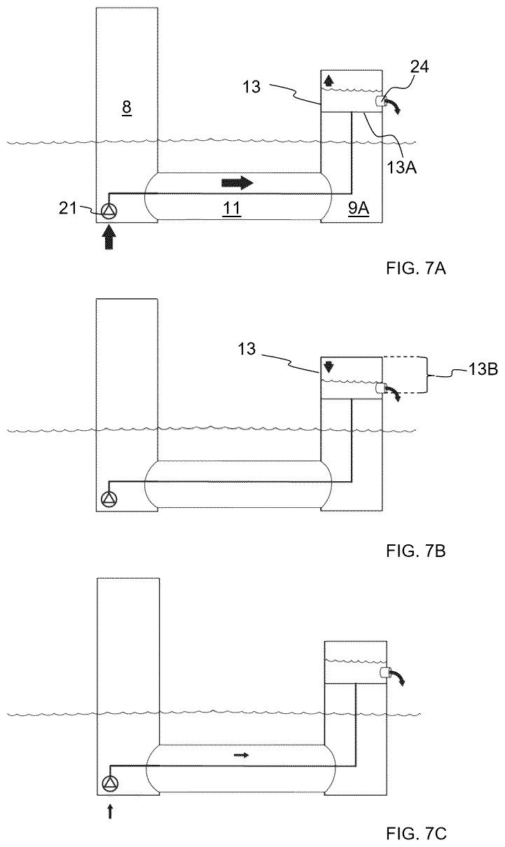

With general reference to the reference numbers of FIG. 5, of which only a few are used in FIGS. 7A-7C, although, they find equal application, FIG. 7A illustrates an embodiment in which a pump 21 is used for filling sea water into the adjustable-ballast reservoir 13, which is illustrated by thick arrows. As illustrated in FIG. 7B, water is drained from the reservoir 13 back into the surrounding sea through a drain 24 provided at the reservoir 13. The drain is open at all times, also when the pump 21 is operating. The pump, thus, has to pump water into the reservoir 13 at a higher rate than the draining rate through the drain 24 if the water should rise in the reservoir 13, which is illustrated in FIG. 7A. In order to maintain the water level in the reservoir 13, the pump 21 has to pump at a rate equal to the draining rate, which is illustrated in FIG. 7C. With reference to FIG. 7B, which illustrates a passive drain 24 that is provide as a constantly open drain opening, it is pointed out that the effective volume 13B of the adjustable-ballast reservoir 13 from which water can be drained for adjustment of the ballast is defined by the lower edge of the opening of the drain 24, as water can only be drained until the lower edge of the opening of the drain 24, in this embodiment. However, the drain 24 can be arranged at various levels as needed, for example provided at the bottom 13A of the reservoir 13.

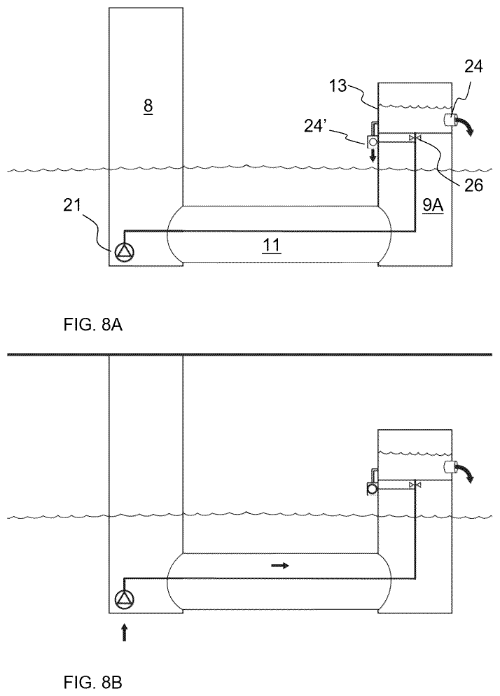

With general reference to the reference numbers of FIG. 5, of which only a few are used in FIGS. 8A and 8B, although, they find equal application, FIG. 8A illustrates an embodiment in which water is drained from the reservoir 13 back into the surrounding sea through a drain 24 provided at the reservoir 13. The drain 24 is open at all times, also when the pump 21 is operating, as illustrated in FIG. 8B. In order to maintain the water level in the reservoir 13, the pump 21 has to pump at a rate equal to the draining rate through drain 24, which is illustrated in FIG. 8B. Optionally, the pumping rate of the pump 20 is regulated by adjusting the speed of the pump 20 to higher or lower of the draining rate through the drain 24. Alternatively, the pump 21 is running at constant speed, and the rate at which the water is added to the reservoir 13 is regulated by a valve 26, which is fluid-flow connected not only to the reservoir 13 but also to an additional drain 24′ so that the sea water pumped by the pump 21 but not entering the reservoir 13 is discarded back into the sea. The additional drain 24′ optionally comprises a valve which can also be used to drain the reservoir quicker than through the drain 24 alone.

What is claimed is:

1. An offshore wind turbine system comprising:
a wind turbine in combination with a semisubmersible support structure configured for floating at a water surface, wherein the support structure comprises a tower support that carries a tower of the wind turbine and at least one buoyancy member providing buoyancy to the support structure and at least one adjustable-ballast reservoir having a water-fillable volume with an effective part of the volume being arranged distal to the tower and configured for receiving water for providing extra load on the support structure by gravitation as a restoring force that counteracts inclination of the tower relative to a predetermined orientation;
wherein the effective part of the volume of the adjustable-ballast reservoir is arranged above the water surface so as to maintain a position above the water surface when in operation even under inclined conditions of the support structure and the wind turbine tower;
a water intake for intake of water under the water surface from the water that surrounds the support structure in operation;
a pump system for pumping the water from the intake through a conduit into the effective part; and
a drain system configured for draining water from the effective part back into the water that surrounds the support structure only by gravity and passively in case of power failure.

2. The system according to claim 1, wherein the effective part of the volume is entirely above the water surface at all times during normal offshore operation irrespective of inclination.

3. The system according to claim 1, wherein the water-fillable volume of the adjustable-ballast reservoir is entirely above the water surface at all times during normal offshore operation irrespective of inclination.

4. The system according to claim 1, wherein the drain system comprises a drain at the adjustable-ballast reservoir.

5. The system according to claim 4, wherein the drain is constantly open.

6. The system according to claim 4, wherein the drain is configured for emptying the effective part of the volume of the adjustable-ballast reservoir in less than six hours if no sea water is added to the adjustable-ballast reservoir.

7. The system according to claim 4, wherein the pump has a capacity for pumping water into the adjustable-ballast reservoir at a pump rate exceeding the drain rate in order to fill the adjustable-ballast reservoir.

8. The system according to claim 1, wherein the drain system comprises an actively controlled drain-valve for draining the adjustable-ballast reservoir through the drain-valve.

9. The system according to claim 8, wherein the drain-valve is configured for being closed during filling of the adjustable-ballast reservoir but being normal-open for automatic drainage from the adjustable-ballast reservoir through the drain-valve in case of a power failure.

10. The system according to claim 1, wherein the pump system comprises a pump that has reverse flow capabilities as part of the drain system and is configured for reverse flow of water from the adjustable-ballast reservoir backwards through the pump and back into the water that surrounds the support structure when the pump is not in operation.

11. The system according to claim 1, wherein the support structure comprises a plurality of adjustable-ballast reservoirs, which are fillable individually and independently from each other by the pump system and from which water can be individually drained by the drain system, and which are distributed at different azimuth angles about the axis of the tower in a plane lateral to the axis for adjusting the inclination of the tower in different lateral directions by individually adding or draining water to and from the adjustable-ballast reservoirs.

12. The system according to claim 11 comprising at least three of such adjustable-ballast reservoirs without flow of water from one to the other of the adjustable-ballast reservoirs.

13. The system according to claim 11, wherein the pump system comprises an individual pump for each of the adjustable-ballast reservoirs, each of the individual pumps pumping the water from the water that surrounds the support structure into only one of the adjustable-ballast reservoirs.

14. The system according to claim 11, wherein the drain system comprises an individual drain for each of the adjustable-ballast reservoirs, each of the drains configured for draining water from only one of the adjustable-ballast reservoirs into the water that surrounds the support structure.

15. The system according to claim 11, wherein the support structure comprises a plurality of buoyancy members providing buoyancy to the support structure, the buoyancy members being arranged at nodes of a polygonal configuration and at distances to the tower support; wherein each of the buoyancy members carries one of the adjustable-ballast reservoirs.

16. The system according to claim 15, wherein each adjustable-ballast reservoir is provided on top of a corresponding buoyancy member.

17. A method for operating an offshore wind turbine system comprising:
providing the offshore wind turbine system of claim 1;
measuring an inclination of the tower which is deviating from a predetermined orientation; and
counteracting the inclination by pumping water from the water that surrounds the support structure into the adjustable-ballast reservoir.

18. The method according to claim 17, further comprising adjusting the inclination of the tower in different lateral directions by individually adding or draining water to and from one or more of a plurality of adjustable-ballast reservoirs, which are fillable individually and independently from each other and are arranged for being individually emptied, and which are distributed at different azimuth angles about the axis of the tower in a plane lateral to the axis.

19. The method according to claim 17, wherein the support structure comprises a plurality of buoyancy members providing buoyancy to the support structure, the buoyancy members being arranged at nodes of a polygonal configuration and at distances to the tower support; wherein each of the buoyancy members carries one of the adjustable-ballast reservoirs, the method comprising measuring an inclination of the tower which is deviating from a predetermined orientation, which is causing at least a first of the buoyancy members to rise higher out of the water and a second of the remaining buoyancy members to sink deeper into the water, and counteracting the inclination by pumping water into the adjustable-ballast reservoir carried by first buoyancy member or by only gravity draining water from the adjustable-ballast reservoir carried by the second buoyancy member, or both.
